(19) United States
(12) Patent Application Publication
(10) Pub. No.: US 2011/0181702 A1
(43) Pub. Date: Jul. 28, 2011

(54) METHOD AND SYSTEM FOR GENERATING A REPRESENTATION OF AN OCT DATA SET

(75) Inventors: Christoph Hauger, Aalen (DE); Martin Hacker, Jena (DE)

(73) Assignee: Carl Zeiss Surgical GmbH, Oberkochen (DE)

(21) Appl. No.: 12/844,696

(22) Filed: Jul. 27, 2010

(30) Foreign Application Priority Data
Jul. 28, 2009 (DE) 102009034994.4

(51) Int. Cl. H04N 13/02; G06K 9/00; H04N 15/00

(52) U.S. Cl. 348/46; 382/131; 348/E13.074

(57) ABSTRACT

A method of generating a representation of an OCT data set includes obtaining the OCT data set, representing a plurality of tuples, each of which comprises values of three spatial coordinates and a value of a scattering intensity, obtaining a color image data set representing a plurality of tuples, each of which comprises values of two spatial coordinates and a color value, and generating an image data set, representing a plurality of tuples, each of which comprises values of three spatial coordinates and a color value. Generating the image data set is performed depending on an analysis of the OCT data set and an analysis of the color image data set.

### CROSS-REFERENCES TO RELATED APPLICATIONS

The present application claims priority to German Patent Application No. 10 2009 034 994.4, filed Jul. 28, 2009, entitled “METHOD AND SYSTEM FOR GENERATING A REPRESENTATION OF AN OCT DATA SET,” the disclosure of which is hereby incorporated by reference in its entirety.

### BACKGROUND OF THE INVENTION

The invention relates to a method for generating a representation of an OCT data set and an OCT system for performing the method.

Optical coherence tomography (OCT) is a comparatively new imaging method which allows displaying three-dimensional structures of an object. In a conventional OCT system, a limited volume of the object is systematically scanned with an OCT measuring beam probe for obtaining scattering intensities of the corresponding scan locations. Typically, these scattering intensities are displayed as grayscale images. Such grayscale images are often not easy to understand, and particular knowledge of the displayed structures and practice in interpreting them is required in order to be able to draw correct conclusions from the displayed data.

### SUMMARY OF THE INVENTION

It is an object to provide an OCT system and an OCT method of generating OCT images having an extended information content.

According to embodiments, an OCT system and an OCT method produce OCT images including color information.

According to exemplary embodiments, a method of generating a representation of an OCT data set comprises obtaining an OCT data set, representing a plurality of tuples, each of which comprises values of three spatial coordinates and a value of a scattering intensity; obtaining a color image data set representing a plurality of tuples, each of which comprises values of two spatial coordinates and a color value; generating an image data set, representing a plurality of tuples, each of which comprises values of three spatial coordinates and a color value; and wherein the generating of the image data set is performed depending on an analysis of the OCT data set and an analysis of the color image data set.

The color image data set may represent a two-dimensional color image.

The values of the three spatial coordinates of the OCT data set may refer to a first coordinate system. The values of two spatial coordinates of the color image data set may refer to a second coordinate system. The values of the three spatial coordinates of the image data set may refer to a third coordinate system.

Two of these coordinate systems or all three of them may be identical. Coordinate systems, which are different, may be transformable such that they are identical. By way of example, coordinate systems which are different may be transformable by a shift and/or a rotation such that they are identical.

Accordingly, the generating of the image data set may comprise transforming the values of the spatial coordinates of at least one of the OCT data set, the color image data set or the image data set such that at least to of these coordinate systems are identical.

According to an embodiment, the analyzing of the OCT data set comprises analyzing values of the scattering intensity of a first group of tuples of the plurality of tuples represented by the OCT data set.

According to a further embodiment the analyzing of the OCT data set further comprises selecting a second group of tuples from the first group such that the second group represents at least one scattering structure within a volume of the OCT data set.

By way of example, the scattering structure may be the cornea, an eyelid or the iris, or parts of these. The scattering structure may therefore be a portion of the object which represents a function, a physical property or a chemical property or a combination of these. The function may be a biological function.

According to another embodiment, each of the tuples of the first group is located along a line, which is oriented parallel to a projection direction.

Thereby, each voxel of the second group of tuples may be located on the line which is oriented parallel to the projection direction.

According to a further embodiment, analyzing the OCT data set further comprises determining a representative depth of the second group of tuples, which is measured along the line from a surface of the volume of the OCT data set.

By way of example, determining the representative depth may comprise calculating an average depth value from depth values of the second group of tuples.

According to a further embodiment, generating the image data set comprises assigning a color value obtained from an analysis of the tuples represented by the color image data set to a location on the surface of the volume, wherein the location on the surface is an intersection of the line with the surface, and projecting the assigned color value from the location on the surface of the volume along the line onto the determined representative depth.

By way of example, a group of color values of the color image and a group of values of the scattering intensity of the OCT data set refer to at least one identical structure of the object.

The surface of the OCT data set and the camera may be arranged such that color values of the color image are assignable to locations on the surface of the OCT data set.

According to further exemplary embodiments, an OCT system comprises an OCT recording device for obtaining an OCT data set, a camera for obtaining a color image data set, a computation device, which is configured to calculate from the OCT data set and the color image data set a data set for a three-dimensional color image, and a display device, for displaying the data set as a three-dimensional color image.

According to exemplary embodiments, the OCT recording device operates according to the principle of time domain OCT. According to other exemplary embodiments, the OCT recording device operates according to the principle of frequency domain OCT, and according to further exemplary embodiments, the OCT recording device may operate according to even further OCT operation principles. Moreover, according to some exemplary embodiments, the beam of laser light may be focused to form beam probe scanning the volume of the object under investigation. According to other exemplary embodiments, the beam of laser is shaped to simultaneously illuminate an extended area of the sample, wherein the measurement is performed in parallel for the extended area by an extended imaging sensor, which may provide a sensor area of a corresponding extent. A wavelength of the laser light may be any of a suitable wavelength, for example 800 nanometers (nm) or 1300 nanometers (nm).

According to embodiments, the OCT recording device is configured to obtain information on the spatial structure of the object under investigation. This information comprises an extent to which the materials of the object scatter the light of the laser, which is used for the OCT measurement. From this information, however, it is not possible to derive a color which corresponds to human color perception.

According to embodiments, the OCT system is configured to obtain spatially dependent color information of the object under investigation with the color camera. The color camera receives color information which corresponds to the spatial structures of the object. The color information received by the camera is a projection on a two-dimensional surface of the camera detector. In other words, the camera is designed to take a two-dimensional color image of the object. The two-dimensional color image may be a projection of the object onto a surface of the camera detector.

Hence, in such embodiments, the information which is obtained by the camera is a two-dimensional information. Based on this projection, it is possible to assign a color value to a volume portion of the object, wherein the color value is detected in a certain portion of the camera and the volume portion of the object is projected onto this portion of the camera. The corresponding portion of the volume of the object is an extended three-dimensional volume region. However, by analysis of the data, which is obtained by the OCT recording device, it is possible to reduce the extent of this volume region and to assign the color information which is obtained by the color camera to a comparatively small spatial portion of the volume of the object.

For example, the OCT recording device may perform a plurality of A-scans, which intersect different locations on the surface of the sample. An A-scan may be defined as an axial depth scan of the OCT system. The color camera may record one or more corresponding color images of these locations on the object's surface. In other words, the locations, where the A-scans intersect the surface of the object may be imaged by the color camera.

It is also conceivable that other scan procedures which are different from A-scans are performed for obtaining OCT data from which the depth of the scattering structure is determined.

The color images may be taken during before or after the A-scan. Through an analysis of the depth scans, it is possible, to determine a depth of scattering structures of the object. The scattering structures may be located for example on or beneath the object's surface. The line along which the depth is measured may be parallel to a projection direction. The depth may be measured from a surface of the volume which is scanned by the OCT recording device. Thereby, a location on the surface of the scanned volume may correspond to the determined depth. The surface of the scanned volume may be oriented perpendicular or substantially perpendicular to an optical axis of the OCT recording device.

According to some embodiments, a color value corresponding to the determined depth is determined by an analysis of the color images taken by the camera.

According to further embodiments, determining of the color value corresponding to the depth comprises projecting the color image onto the surface of the scanned volume. Thereby, color values of the color image are assigned to locations on the surface of the scanned volume.

According to particular embodiments herein, the determining of the color value corresponding to the determined depth includes using the color value assigned to the location on the surface of the scanned volume.

This may have an effect of projecting the selected color value onto the determined depth. The projection of the selected color value may be performed along a projection direction parallel to a direction along which the depth is measured.

Hence, selected color value may be projected along the projection direction from the surface of the scanned volume onto the determined depth. In other words, the two-dimensional color image, which is recorded by the color camera, may be projected onto a three-dimensional structure. The three-dimensional structure may be identified based on an OCT data set measured by the OCT recording device.

### BRIEF DESCRIPTION OF THE DRAWINGS

The forgoing as well as other advantageous features of the invention will be more apparent from the following detailed description of exemplary embodiments of the invention with reference to the accompanying drawings. It is noted that not all possible embodiments of the present invention necessarily exhibit each and every, or any, of the advantages identified herein.

Exemplary embodiments of the invention are explained in the following by referring to the Figures.

FIG. 1 shows a schematic illustration of an OCT system;

FIG. 2 shows a schematic illustration of an OCT data set, a color image data set and an image data set. The image data set is obtained from the OCT data set and the color image data set; and

FIG. 3 shows a further schematic illustration of an OCT data set.

### DETAILED DESCRIPTION OF THE INVENTION

In the exemplary embodiments described below, components that are alike in function and structure are designated as far as possible by alike reference numerals. Therefore, to understand the features of the individual components of a specific embodiment, the descriptions of other embodiments and of the summary of the invention should be referred to.

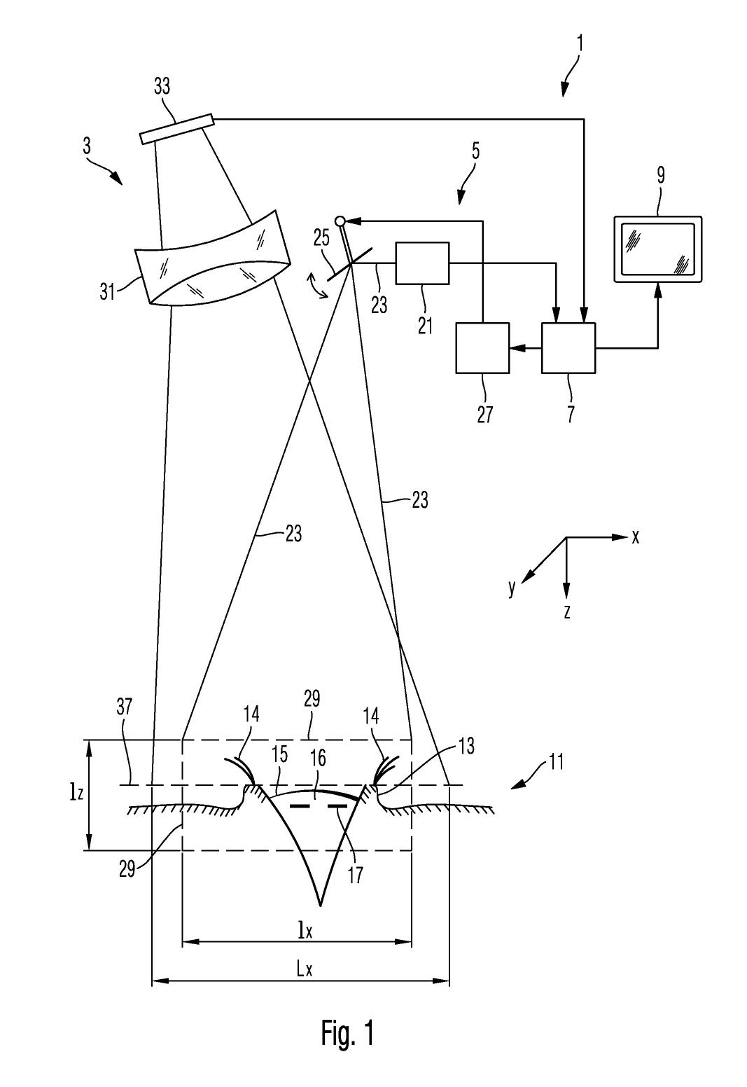

FIG. 1 shows an OCT system 1 comprising a camera 3, an OCT recording device 5, a computation device 7 and a display device 9. The example, which is illustrated in FIG. 1 is configured to generate a three-dimensional representation of structures of a human eye 11. The eye 11 comprises eyelids 13 having eyelashes 14, the cornea 15, the anterior chamber 16, the iris 17 and further structures. The anterior portion of the eye 11 is described in conjunction with the embodiment of the OCT system 1 only as an example for a suitable object which can be observed and investigated with the OCT system 1. It is also conceivable that other structures of the human eye, such as the retina, are observed and investigated. Moreover, also other parts of the human body or structures of biological samples or inorganic samples or structures of technical devices and products may be observed and investigated. Generally speaking, the OCT system 1 can be used to investigate samples, which are suitable for investigation by the method of optical coherence tomography (OCT).

The OCT recording device 5 comprises an interferometer 21. The object 11 is arranged in the object path (i.e. in the measurement path), of the interferometer 21. A laser beam 23 of the object path is incident on a scanning mirror 25, which directs the laser beam 23 onto the object 11. A controller 27 controls the scanning mirror 25 such that the location of incidence of the laser beam 23 at the object 11 is systematically varied. In other words, the laser beam 23 is scanned over the object 11. At each scanning position of the laser beam 23, i.e. at each location of incidence, a depth profile of scattering strengths of the object may be obtained by the interferometer 21. Thereby, scattering data may be obtained from a volume, which is shown in FIG. 1 and denoted by reference sign 29. In other words, this volume may represent the scanned volume 29 of the OCT recording device 5. The volume 29 has a first extension lx in a first lateral direction x. Furthermore, the volume 29 has a second extension ly in a second lateral direction y, wherein the second lateral direction y is oriented orthogonally to the first lateral direction x. The volume 29 further has a third extension lz in a transversal direction z, wherein the transversal direction z is oriented orthogonally to the first lateral direction x and the second lateral direction y. The eye 11 is positioned in relation to the OCT recording device 5 such that an anterior portion of the eye 11 is located within the volume 29.

The camera 3 comprises an optical system 31 and an image sensor 33. The optical system 31 images an object field 37 onto the image sensor 33. The optical system 31 may comprise one or more lenses. The image sensor 33 may be a suitable CCD-sensor or CMOS-sensor or the like. The image sensor 33 may be configured to detect a color image. In other words, the image sensor 33 may be configured to obtain color signals, which are dependent on position and intensity, i.e. intensity signals which are position dependent and which represent color. In the illustrated example, the camera 3 comprises a single image sensor 33, which is designed such that positionally dependent intensity values are detectable for three different colors. It is also conceivable, that the camera 3 comprises a plurality of image sensors, wherein each image sensor is configured to detect intensity values of a single color.

The camera 3 is positioned in relation to the OCT recording device 5 such that an object plane 37, which is imaged onto the image sensor 33, is at least partially overlapping with the volume 29, which is scanned by the OCT recording device 5. In other words, the object plane 37 is located partially inside an partially outside of the volume 29. The object plane 37 has a first extension lx in the first lateral direction x and a second extension ly in a second lateral direction y, wherein the following relation holds:
Lx>lx and Ly>ly

In other words, in the exemplary embodiment, which is illustrated in FIG. 1, a first lateral extension Lx of the object field 37 of the camera 3 is larger than a lateral extension lx of the object volume 29 of the OCT recording device. Furthermore, the second lateral extension Ly of the object field 37 of the camera 2 is larger than a second lateral extension ly of the object volume 29.

However, this relation is not a mandatory requirement. It is also conceivable that the first lateral extension lx of the recording volume 29 of the OCT recording device 5 is larger than the first lateral extension Lx of the object field 37 of the camera 3 and that the second lateral extension ly of the recording volume 29 of the OCT recording device 5 is larger than the second lateral extension Ly of the object field 37 of the camera. Also, it is conceivable that the first and second lateral extension lx, ly of the recording volume 29 of the OCT recording device 5 is equal to the first and second lateral extension Lx, Ly of the object field 37 of the camera 3.

In the illustrated exemplary embodiment, the optical system 31 of the camera 3 is configured such that the object plane 37 seen in the transversal direction z is located approximately in the middle of the object volume 29. However, this relation is not a mandatory requirement. The object plane 37 may be located at different positions in relation to the volume 29. In particular, the object plane 37 may be located outside of the volume 29. For example, referring to FIG. 1, the object plane 37 may be located above or beneath the volume 29, when seen along the transversal direction z. The OCT system 1 may be configured such that a surface of the object 11, which is located inside the recording volume 29 is imaged with a sufficient image sharpness on the image sensor 33.

By scanning the volume 29 with the OCT recording device 5, an OCT data set is obtained, which represents a spatial distribution of scattering intensities of the object 11. The OCT data set is processed by a computation device 7 and is projectable on a plane for generating a display or a representation of the OCT data set. The display or representation may be shown on the screen 9. In case the OCT data set, which is obtained by scanning the volume 29, in which the eye 11 is located, is directly displayed (i.e. without combining it with color information), the representation may appear similar than that which is shown in FIG. 6 of the previously mentioned article of Ireneusz Grulkowski et al. FIG. 6 of this article shows an image consisting of grayscale values, which represent scattering strengths.

Since the camera 3 records a color image of the object 11, it is possible, to extract color information from the color image. The color information may be assigned to the spatial structures of the OTC-data set such that for example in the representation or display of the OCT data set, the eyelids 13 appear in skin color, the cornea 15 appears white colored and the iris 17 appears in its natural color.

The recording of the OCT data set and the color image as well as the representation or display of the processed OCT data set, as described in the following, can be performed in real-time. Thereby for example, during observing the representation on the display 9 (FIG. 1), the doctor may perform medical or surgical procedures on the eye 11.

This may be performed by projecting the information of the color image on the structures of the OCT data set. The projection may be performed along a projection direction. By way of example, the color value of a pixel of the color image may be projected along a projection direction onto a at least a voxel of the OCT data. Thereby, the color value may be assigned to the at least one voxel. The projection direction may be oriented parallel to the optical axis of the camera 3. Also, the projection direction may be oriented parallel to the optical axis of the OCT recording device 5.

It is also conceivable that the projection direction is selected according to the geometry of the object under investigation.

The projection direction may be different for different portions of the OCT data set.

The optical axis of the camera 3 may be inclined with respect to the optical axis of the OCT recording device 5. For example, the optical axis of the camera 3 do not intersect the optical axis of the OCT recording device 5 or the optical axis of the camera 3 intersect and form an angle of inclination. It is also conceivable, that the optical axis of the camera 3 is oriented parallel or substantially parallel to the optical axis of the OCT recording device 5.

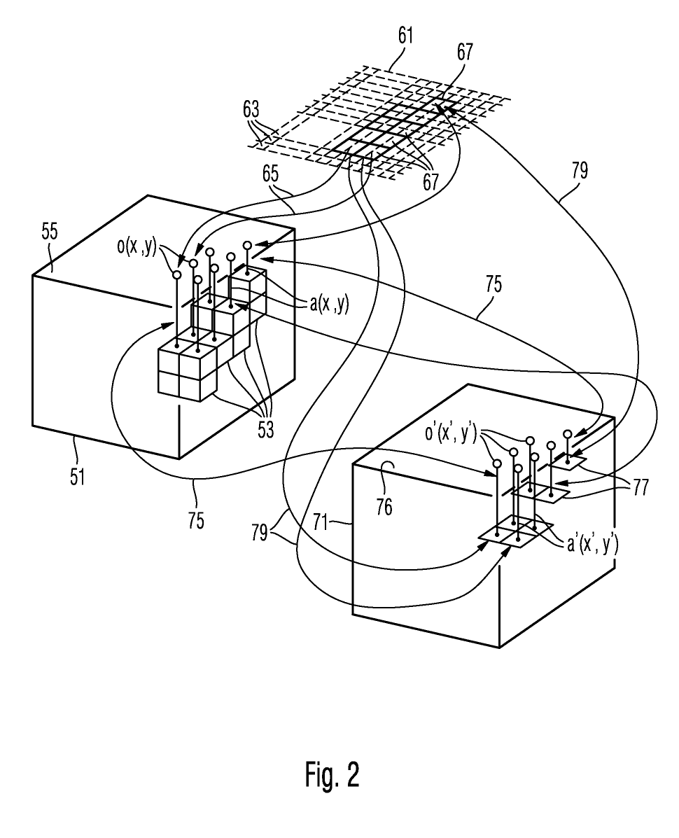

The process of projecting the information of the color image on the structure of the OCT data set is illustrated in FIG. 2. A cuboid 51 represents an OCT data set, which is obtained by the OCT recording device 5. The OCT data set 51 contains values of scattering intensities for different locations of the scanned volume 29. The locations may be divided into a periodical grid for the coordinates x, y and z, wherein to each of the volume elements, or voxels, of the grid is assigned a value for the measured scattering intensity. In FIG. 2, there are illustrated only some of these voxels as small cubes 53. It is assumed that the scattering intensities of these voxels 53 are high in comparison to the scattering intensities of other voxels. Therefore, the voxels 53 represent a comparatively strongly scattering structure of the object, which is thereby readily visible. A step of generating the representation further comprises determining of distances of the selected voxels 53 from a surface 55 of the cuboid 51. The distances are measured along the z-direction and are assigned to the respective locations O(x,y). The locations O(x,y) are located on the surface 55 above the respective voxels 53 and represent a projection along the z-direction. Hence, the z-direction is the projection direction. The distances a(x,y) between the locations O(x, y) and the corresponding voxels thereby correspond to the depth in the measuring volume 29, at which scattering structures are located.

An area 61, which is illustrated in FIG. 2, represents the color image data set, which is recorded by the camera 3. The color image data set comprises a periodically two-dimensional grid of picture elements or pixels 36. Each of the pixels 63 represents a location dependent color value. The color value may be represented by suitable values, such as three intensity values for each of the colors red, green and blue (RGB). Alternatively or additionally, the color value may be represented by three values representing hue, saturation and intensity (HIS). Also additionally or alternatively, another combination of values, which is suitable for representing a color value, may be used.

A step of generating the representation of the OCT data set comprises assigning pixels 63 to locations O(x,y) on the surface 54. This may be performed in various ways. For example, the assigning of the pixels 63 to the locations O(x,y) may be performed by a calculation which is based on the position of the camera 3 in relation to the position of the OCT recording device 5. Moreover, the calculation may also be based on properties of the imaging optical system 31 or the scanning mirror 25 or a combination of these properties. Additionally or alternatively, a test object, which for example represents a periodical pattern, can be used for determining the assigning of the pixels 63 to the locations O(x,y). In particular in the case when the lateral resolving power of the camera 3 is higher than the lateral resolving power of the OCT recording device, to each of the locations O(x,y) may be assigned a plurality of pixels 63. This plurality of pixels 63 may be neighboring pixels. By way of example, in the illustration of FIG. 2, to each of the locations O(x,y), a group 67 of four pixels 63 is assigned. The assignment of the pixels 63 to the locations O(x,y) is illustrated in FIG. 1 by arrows 65.

By way of example, the step of assigning the pixels to the locations O(x,y) may be performed by projecting the pixels 63 along the optical axis of the camera 3 from the object plane 37 of the camera 3 onto the surface 55.

In FIG. 2, a cuboid 71 illustrates an output data set, which is generated by the computation device 7 based on the OCT data set 51 and the color image data set 61. The output data set comprises a plurality of locations O′(x′,y′), which corresponds to the locations O(x,y) of the OCT data set 51. The output data set 71 further comprises distances a′(x′,y′), which are assigned to the locations O(x′,y′) and which correspond to the distances a(x,y) of the OCT data set 51. The correspondence between the distances a(x,y) of the OCT data set 51 and the distances a′(x′,y′) of the output data set 71 is illustrated in FIG. 2 by arrows 75. The distances a′(x′,y′) represent distances measured from a surface 76 of the cuboid 71. Thereby, the distances a′(x′, y′) represent depths, which are measured along the z-direction of the scanned volume 29. The output data set 71 further comprises image elements 77, each of which represents a color value, which is calculated based on a group 67 of pixels 63 of the color image data set 61. The assigning of the groups 67 of pixels 63 of the color image data set 61 to the elements 77 of the output data set 71 is illustrated in FIG. 2 by arrows 79.

Therefore, the output data set 71 comprises parts of the information of the spatial structure of the object under investigation from the OCT data set 51 and the color information of the object under investigation from the color image data set 61. The output data set 71 may be visualized by a projection on a plane and displaying this projection on a screen. The displayed representation may be similar to that shown in FIG. 6 of the publication of Ireneusz Grulkowski et al. However, it is different in that natural colors instead of grayscale values lead to a realistic three-dimensional representation of the structures of the object under investigation.

A particularly realistic representation may be attained in particular by applying one or more of the following aspects:

(a) An assignment 65 of elements O(x,y) or locations O(x,y) of the OCT data set 51 to groups 67 of pixels 63 of the color image data set 61, wherein the elements O(x,y) or locations O(x,y) of the OCT data set 51 correspond to values of coordinates in a lateral direction x,y of the scanned volume 29 of the OCT recording device 5.

(b) The group 67 of pixels 63 may comprise one or more pixels 63. Groups 67, which may be different, may comprise pixels 63 which are identical among these groups 67.

(c) Distances a(x,y), which may be calculated for the locations O(x,y), based on voxels 53 of the OCT data set 51, which are located side by side along a line starting from an element O(x,y) or location O(x,y) and extending in a direction transversal to the lateral directions x,y. This direction may be referred to as the projection direction. In the illustrated example, this direction is the z-direction. In other words, in the illustrated example, the line is orthogonally oriented to the lateral directions x,y. However, the line, i.e. the projection direction, may also extend into a direction which is not exactly parallel to the z-direction, but forms an angle greater than 0 degree with the z-direction. The direction, along which the line extends, may correspond to an orientation of the camera 3 relative to the scanned volume 29. Hence, the projection direction ma be oriented parallel to the optical axis of the camera 3. In the example, which is illustrated in FIG. 1, this orientation is the vertical direction. However, it is also conceivable that the projection direction is oriented parallel or substantially parallel to the optical axis of the OCT recording device 5 in the object region.

(d) The group of voxels 53, which are located in the described projection direction under a location O(x,y) are subject to a separate analysis. This separate analysis may for example be conducted for determining a distance a(x,y) of a stronger scattering structure which is located beneath the surface 55. This separate analysis is based on values of the scattering intensities of the voxels 53. For example, a voxel, which has a scattering intensity which exceeds a predetermined or pre-selected threshold value, may define the distance a(x,y). It is also conceivable that a voxel, which has a scattering intensity which represents a local maximum of the scattering intensities of the voxels 53, which are located along the described projection direction, may define the distance a(x,y). It is further conceivable that changes in values of the scattering intensities of the voxels 53 along the projection direction are be determined. Thereby, a voxel at which the scattering intensity increases much stronger than a predetermined or pre-selected difference value, may define the distance a(x,y).

(e) The step of assigning 75 the distances a(x,y) of the OCT data set to distances a′(x′,y′) of the output data set 71. The assigning may be performed in any suitable way and may comprise applying at least one of a scaling factor or an offset.

(f) The step of assigning 79 color values, which are determined from color values of pixels 63 of a group 67 of the color image data set 61 to color values of image elements 77 of the output data set 71.

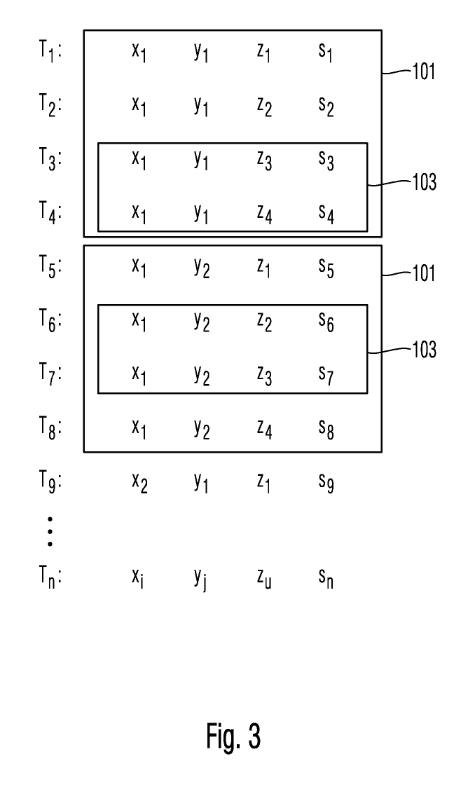

The representation of the OCT data set 51 as cuboid having voxels 53, the representation of the color image data set 61 having pixels 63 and the representation of the output data set 71 having image elements 77 is by way of illustration and not by way of limitation. Generally, the information of the OCT data set 51 may be represented as a set of tuples, wherein each of the tuples comprises three spatial coordinates x,y and z and a scattering intensity s. In FIG. 3, some of these tuples Ti are illustrated. Tuples T1 to T4 are combined to a group 101 and T5 to T8 are combined to a group 101. Each of the groups 101 represents a so-called A-scan. An A-scan comprises scattering intensities s for different values z1, z2, z3 and z4 of the z-coordinate which is oriented in the transversal direction and same values for the coordinates, which are oriented in the first lateral direction x and the second lateral direction y.

Within each of the groups 101, the tuples are sorted in view of increasing values of the z-coordinate. In the illustration of FIG. 3, each of the groups 101, i.e. each of the A-scans, has four tuples. However, in practice the number of tuples may be much higher.

For each of the groups 101 of tuples Ti, an analysis of the values of the si of the scattering intensity is performed. In particular an analysis of the dependence of values si of the scattering intensity from the z-coordinate zi may be performed. Through the analysis, a subgroup 103 of tuples Ti of the group 101 is determined. Each of the subgroups 103 may comprise one or more tuples. By way of example, the analysis may be performed such that it is started at the tuple, which has the smallest value zi of the tuples in the group 101 of tuples. Then, the analysis proceeds for those tuples, which have increasingly higher values of zi. In other words, the tuples of the group 101 are analyzed in an order of increasing values of zi. Hence, the analysis depends on the z-coordinate zi.

According to an example, the tuple, which first exceeds a predetermined or preselected threshold value of the scattering intensity si is assigned to the group 103. The threshold value may for example be determined based on an analysis of the values of the scattering intensities of the tuples, which are in the group 101. Also, it is conceivable that the threshold value is determined based on tuples, of different groups 101, or even all tuples, which have been measured in the volume 29 by the OCT recording device.

According to another example, the analysis can be performed such that starting from the smallest value zi, those tuples are assigned to the group 103, which have a value si of the scattering intensity, which exceeds a predetermined or pre-selected threshold value for a predetermined or pre-selected number of time. For example, those tuples are assigned to the group 103, which have a value si of the scattering intensity, which exceeds the threshold value for second or third (or even more) time.

It is further conceivable that the analysis is performed such that starting from the smallest value zi, those tuples are assigned to the group 103, which have a value si of the scattering intensity, which reaches a maximum for a pre-selected or predetermined number of time. For example, those tuples are assigned to the group 103, which reaches a maximum for the second or third (or even more) time.

It is further conceivable that also those tuples are assigned to the group 103, which are neighboring to those, which have been assigned to the group 103 by one of the above-described variants of analysis or an equivalent method.

For example, an analysis can be performed such that starting from the smallest z-value, the first two, five or ten (i.e. any predetermined or preselected number) of tuples, which are located adjacent to each other and which exceeds a predetermined or preselected threshold value, are assigned to the group 103.

According to a further example, the analysis may be performed such that starting from the smallest z-value, those tuples are assigned to the group 103, at which, compared to the preceding tuples, a change of the value of the scattering strength occurs, which exceeds a predetermined or preselected threshold value.

Assigning the tuples to the group 103 may be performed based on information on the object under investigation. That information may be retrieved from the OCT data set, from the color image data set or from an other or further analysis method. For example, it is known, that the cornea of an eye reflects a detectable OCT signal at the clear transparent region at the interface to the air. The tuples, which correspond to the surface of the cornea may be excluded from further analysis. Thereby, only tuples may be assigned to the group 103, which represent scattering intensities of structures, which are located deeper within the eye. Thereby, the determining of the depth at which the corresponding color image will be projected, is based only on these tuples, which are located deeper within the eye.

Therefore, the groups 103 of tuples represent scattering structures within the scanned volume 29.

For each of the groups 103 of tuples, a representative z-value is determined. By way of example, this can be performed by calculating an average value of the z-values of the tuples of the group 103. According to a further example, the smallest z-value of the tuples of the group 103 is taken as the representative z-value. The representative z-value may be scaled or provided with an offset for determining the distance a′(x′,y′) which represents the z-value which is comprised by the tuples of the output data set.

The output data set comprises tuples, which comprise values for three coordinates. One coordinate value is determined based on the representative z-value according to the passage of the description which refers to FIG. 3. Two further coordinates may be determined directly from the values xi, yi of the tuples, which are illustrated in FIG. 3. Alternatively, these further coordinates may be determined form the values xi, yi of the tuples, which are illustrated in FIG. 3, by scaling or shifting or the like. The tuples of the output data set 71 further comprise a color value, which is calculated based on the color values of the groups 67 of pixels of the color image data set.

While the invention has been described with respect to certain exemplary embodiments thereof, it is evident that many alternatives, modifications and variations will be apparent to those skilled in the art. Accordingly, the exemplary embodiments of the invention set forth herein are intended to be illustrative and not limiting in any way. Various changes may be made without departing from the spirit and scope of the present invention as defined in the following claims.

What is claimed is:

1. A method of generating a representation of an OCT data set, the method comprising:
obtaining the OCT data set, representing a plurality of tuples, each of which comprises values of three spatial coordinates and a value of a scattering intensity;
obtaining a color image data set representing a plurality of tuples, each of which comprises values of two spatial coordinates and a color value; and
generating an image data set, representing a plurality of tuples, each of which comprises values of three spatial coordinates and a color value;
wherein the generating of the image data set is performed depending on an analysis of the OCT data set and an analysis of the color image data set.

2. The method of claim 1 wherein the analysis of the OCT data set comprises analyzing values of the scattering intensity of a first group of tuples of the plurality of tuples represented by the OCT data set.

3. The method of claim 2 wherein the analysis of the OCT data set further comprises selecting a second group of tuples from the first group such that the second group represents at least one scattering structure within a volume of the OCT data set.

4. The method of claim 2 wherein each of the tuples of the first group is located along a line that is oriented parallel to a projection direction.

5. The method of claim 4 wherein the analysis of the OCT data set further comprises determining a representative depth of the second group of tuples, which is measured along the line from a surface of the volume of the OCT data set.

6. The method of claim 5 wherein the generating of the image data set comprises:
assigning a color value obtained from an analysis of the tuples represented by the color image data set to a location on the surface of the volume, wherein the location on the surface is an intersection of the line with the surface, and
projecting the assigned color value from the location on the surface of the volume along the line onto the determined representative depth.

7. The method of claim 1 wherein the three spatial coordinates of the tuples represented by the image data set comprise a first coordinate oriented in a first lateral direction, a second coordinate oriented in a second lateral direction and a third coordinate oriented in a transversal direction,
wherein the method comprises for at least one image data tuple of the plurality of tuples represented by the image data set:
determining a value of the third coordinate of the image data tuple from the analysis of the OCT data set; and
determining a color value of the image data tuple from the analysis of the color image data set.

8. The method of claim 7 wherein the three coordinates of the tuples of the OCT data set comprise a first coordinate oriented in the first lateral direction, a second coordinate oriented in the second lateral direction, and a third coordinate oriented in the transversal direction,
wherein determining the value of the third coordinate of the image data tuple comprises selecting a first group of tuples of the OCT data set such that the values of the first coordinate and the second coordinate of each tuple of the first group correspond to the values of the first coordinate and the second coordinate of the image data tuple.

9. The method of claim 8 further comprising:
selecting a second group of tuples of the OCT data set from the first group; and
determining the value of the third coordinate of the image data tuple depends on values of the third coordinate of the tuples of the second group.

10. The method of claim 9 wherein each of the tuples of the second group comprises higher values of scattering intensity than tuples of the first group, wherein the tuples of the first group are not tuples of the second group.

11. The method of claim 9 further comprising determining a change of the values of the scattering intensity of the tuples of the first group depending on the values of the third coordinate of the tuples of the first group, wherein the tuples of the second group are selected depending on the determined change.

12. The method of claim 7 wherein the two coordinates of the tuples represented by the color image data set comprise a first coordinate oriented in the first lateral direction and a second coordinate oriented in the second lateral direction, wherein determining the color value of the image data tuple comprises:
selecting a third group of tuples represented by the color image data set such that the values of the first coordinate and the second coordinate of the tuples of the third group correspond to the values of the first and the second coordinates of the image data tuple.

13. The method of claim 12 further comprising determining the color value of the image data tuple in dependence of the color values of the tuples of the third group.

14. The method of claim 1 further comprising generating a representation of the image data set.

15. The method of claim 1 wherein each of the tuples represented by the OCT data set and the tuples represented by the image data set are configured such that at least more than 125 different values are storable for the value the third coordinate.

16. The method of claim 1 wherein the color value of the tuples represented by the color image data set and the color value of the tuples represented by the image data set are configured such that at least more than 125 different color values are storable.

17. A method of generating a representation of an OCT data set, the method comprising:
obtaining the OCT data set, wherein the OCT data set represents scattering intensities of a limited volume, wherein the scattering intensities are assigned to voxels and wherein the volume is limited by at least a surface;
obtaining a color image data set representing pixels of color values that are assigned to an area;
determining at least one depth value that is assigned to a location on the surface and wherein the depth value corresponds to a distance measured along a projection direction from the surface, wherein the depth value is determined depending on values of a scattering intensity of voxels that are located along a line, wherein the line intersects the location on the surface to which the depth value is assigned and is directed along the projection direction;
determining at least one group of pixels of the color image data set, wherein the group is assigned to the depth value and wherein a location of the group on the area corresponds to the location on the surface to which the depth value is assigned;
determining a color value for the group depending on the color values of the pixels of the group; and
displaying the determined color value at a location of display, which is determined depending on the depth value to which the group is assigned and also depending on the location on the surface to which the depth value is assigned.

18. An OCT system comprising:
an OCT recording device for obtaining an OCT data set;
a camera for obtaining a color image data set;
a computation device configured to calculate a data set for a three-dimensional color image from the OCT data set and the color image data set; and
a display device operable to display the data set as the three-dimensional color image.

19. The OCT system of claim 19 wherein the data set represents a plurality of tuples, each of which comprises coordinate values taken along three different spatial directions and a color value;
wherein the plurality of tuples includes more than 125 different values for each of the three coordinate values.

20. The OCT system of claim 19 wherein the plurality of tuples includes more than 125 color values.

21. The OCT system of claim 19 wherein the OCT recording device and the camera are oriented in relation to each other such that the color image data set and the OCT data set represent the same structures of an object.
